(19) United States
(12) Patent Application Publication
(10) Pub. No.: US 2026/0196037 A1
(43) Pub. Date: Jul. 9, 2026

(54) INFORMATION PROCESSING APPARATUS

(71) Applicant: NEC Corporation, Tokyo (JP)

(72) Inventor: Kento Morita, Tokyo (JP)

(73) Assignee: NEC Corporation, Tokyo (JP)

(21) Appl. No.: 19/428,777

(22) Filed: Dec. 22, 2025

(30) Foreign Application Priority Data
Jan. 7, 2025 (JP) 2025-002427

(51) Int. Cl. G06V 10/98; G06V 10/74

(52) U.S. Cl. CPC G06V 10/993; G06V 10/74

(57) ABSTRACT

An information processing apparatus includes an acquisition unit that obtains image data including an inspection target as a subject and identification information for identifying the inspection target, and a detection unit that detects an anomaly by comparing an individual that serves as the inspection target identified according to the identification information with past data for each individual.

### INCORPORATION OF BASIC APPLICATION

The present invention is based upon and claims the benefit of the priority of Japanese Patent Application No. 2025-002427 filed on January 7, 2025 in Japan, the disclosure of which is incorporated herein by reference in its entirety by reference.

### TECHNICAL FIELD

The present invention relates to an information processing apparatus, an information processing method, and a storage medium.

### BACKGROUND ART

A technique used to detect an anomaly using image data is known.

For example, PTL 1 discloses an anomaly determination management device including an anomaly determination unit. According to PTL 1, the anomaly determination unit determines presence or absence of an anomaly in an inspection target based on normal image stored in a normal image storage unit and an inspection image stored in an inspection image storage unit. PTL 1 also discloses that a machine learning method trained in advance may be used to determine the presence or absence of an anomaly in the inspection target.

PTL 1: JP 2023-167049 A

### SUMMARY

For example, in a case where any device or the like existing under a train is to be subject to inspection, the number of devices that may be subject to the inspection equals the number of trains. In such a case where there is a plurality of candidates for the inspection target, dirt, characteristics, and the like unique to an individual may be detected as anomalies if training is carried out by collecting normal images without considering individual differences. As a result, there has been a problem that it may be difficult to appropriately detect a state different from a normal state as an anomaly without detecting dirt or the like present on the individual as an anomaly.

In view of the above, an object of the present disclosure is to provide an information processing apparatus, an information processing method, and a storage medium that may solve the problem described above.

In order to achieve such an object, an information processing apparatus according to the present disclosure includes an acquisition unit that obtains image data including an inspection target as a subject and identification information for identifying the inspection target, and a detection unit that detects an anomaly by comparing an individual that serves as the inspection target identified according to the identification information with past data for each individual.

An information processing method according to the present disclosure causes an information processing apparatus to obtain image data including an inspection target as a subject and identification information for identifying the inspection target, and detect an anomaly by comparing an individual that serves as the inspection target identified according to the identification information with past data for each individual.

A storage medium according to the present disclosure is a computer-readable storage medium storing a program for causing an information processing apparatus to obtain image data including an inspection target as a subject and identification information for identifying the inspection target, and detect an anomaly by comparing an individual that serves as the inspection target identified according to the identification information with past data for each individual.

According to the configurations as described above, an anomaly may be appropriately detected.

### BRIEF DESCRIPTION OF THE DRAWINGS

FIG. 1 is a diagram illustrating an outline of an anomaly detection system according to a first example embodiment of the present disclosure;

FIG. 2 is a block diagram illustrating an exemplary configuration of an anomaly detection device;

FIG. 3 is a diagram illustrating exemplary processing of a target extraction unit;

FIG. 4 is a diagram illustrating an outline of a master image update;

FIG. 5 is a diagram for explaining an exemplary process of the master image update;

FIG. 6 is a diagram illustrating exemplary frames to be used for the master image update;

FIG. 7 is a diagram illustrating exemplary preprocessing;

FIG. 8 is a diagram illustrating an outline of an anomaly detection process;

FIG. 9 is a diagram illustrating exemplary processing of an anomaly detection unit;

FIG. 10 is a diagram for explaining exemplary images to be used for anomaly detection;

FIG. 11 is a diagram illustrating an exemplary output of an output unit;

FIG. 12 is a flowchart illustrating an exemplary operation of the anomaly detection device;

FIG. 13 is a block diagram illustrating an exemplary hardware configuration of an information processing apparatus according to a second example embodiment of the present disclosure;

FIG. 14 is a block diagram illustrating an exemplary configuration of the information processing apparatus; and

FIG. 15 is a flowchart illustrating an exemplary operation of the information processing apparatus.

### EXAMPLE EMBODIMENT

### First Example Embodiment

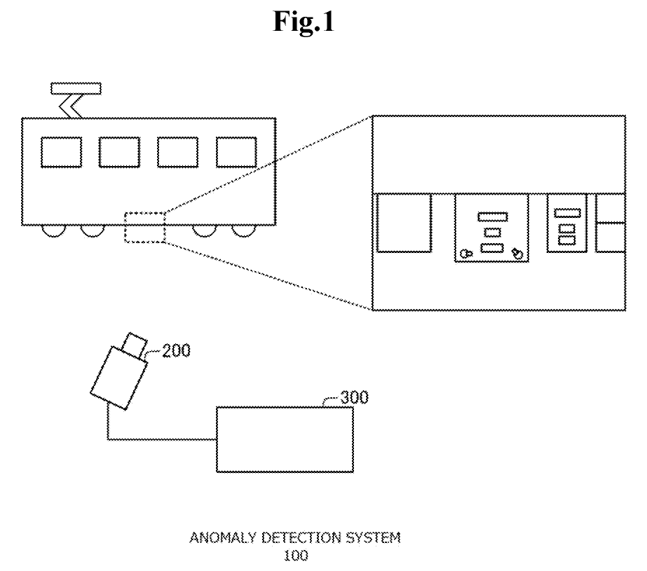

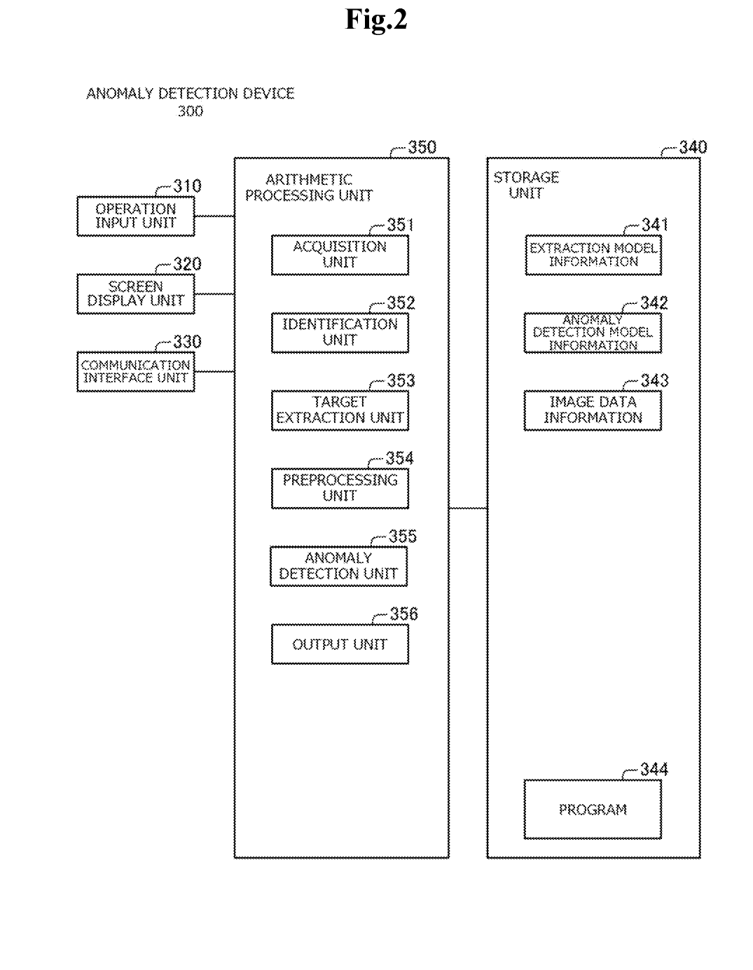

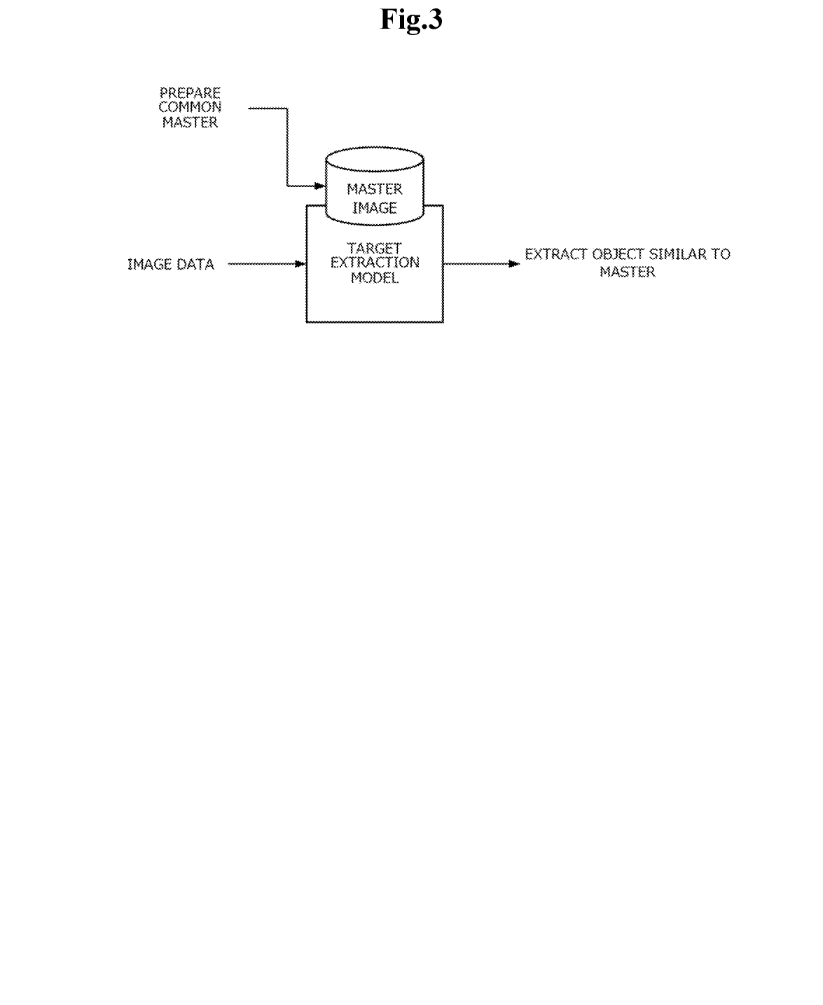

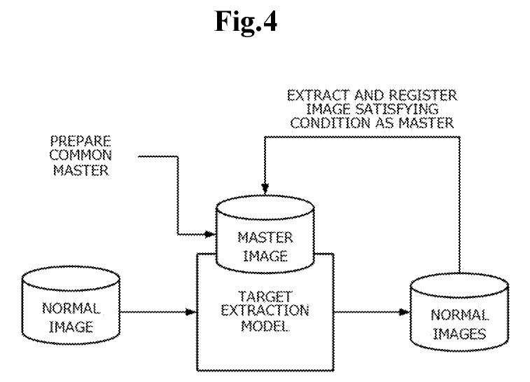

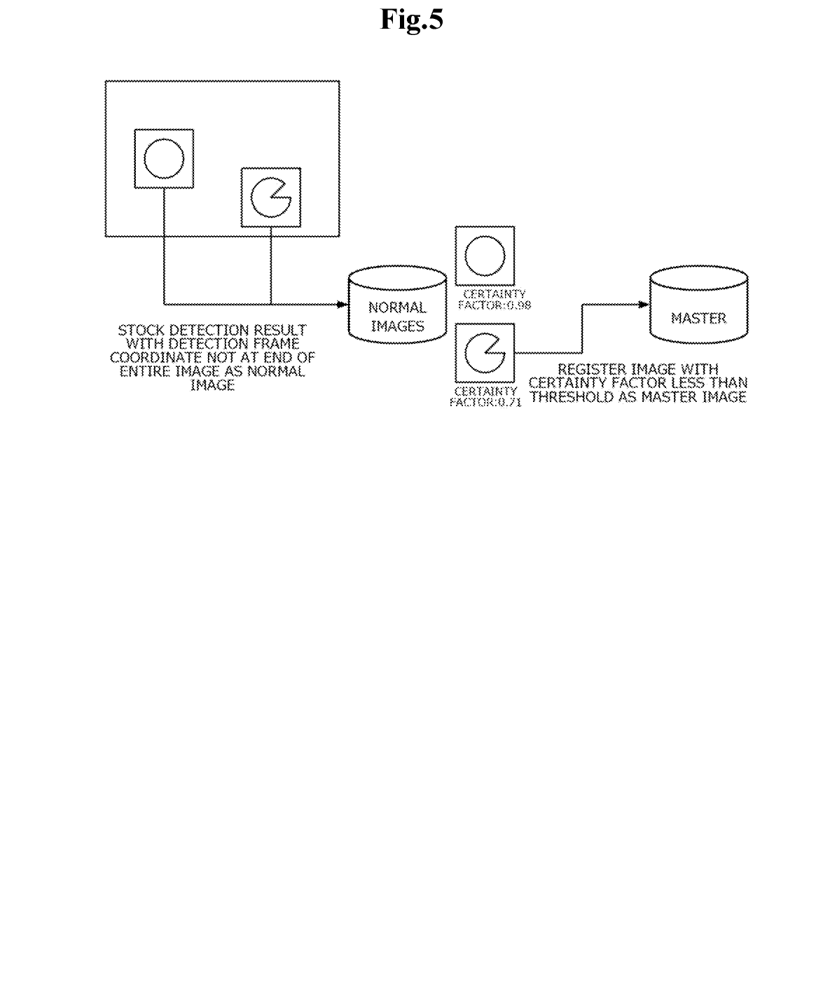

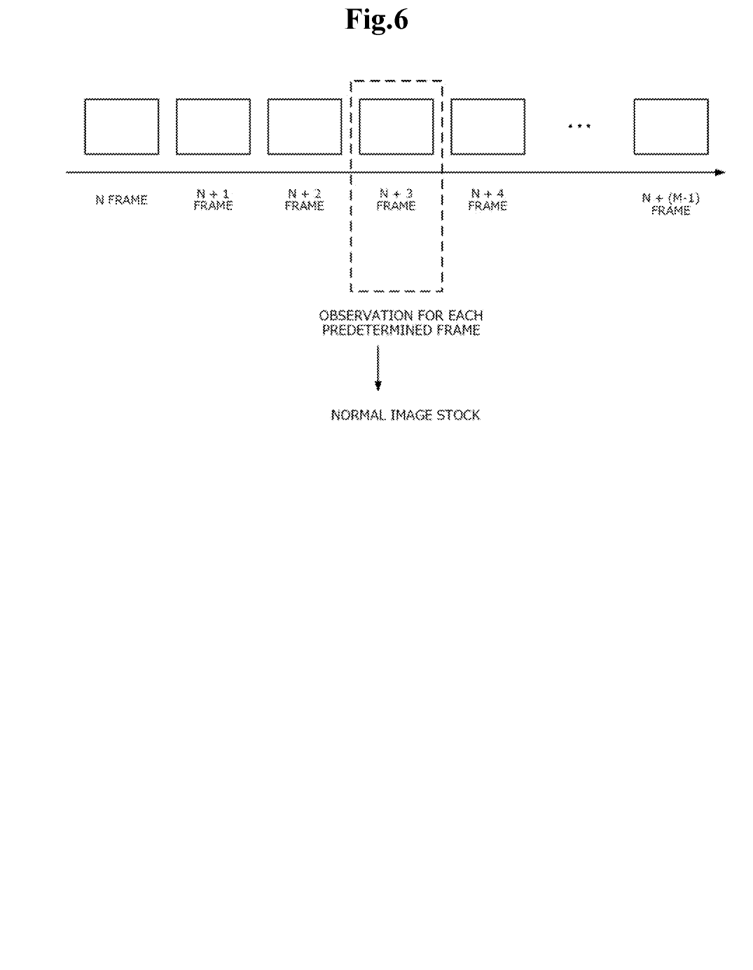

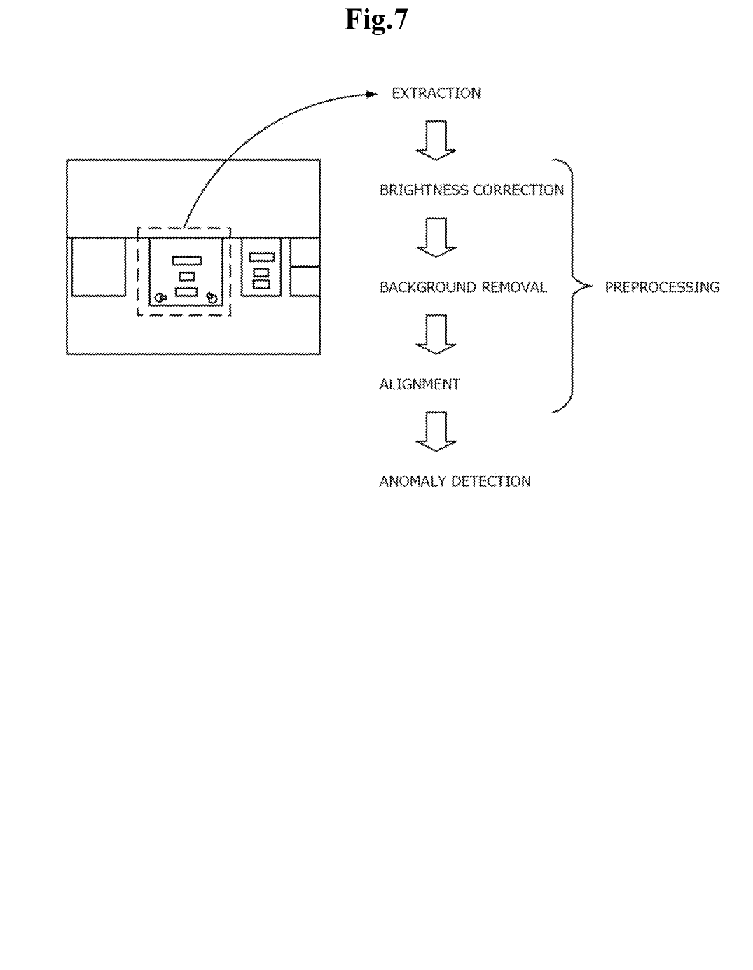

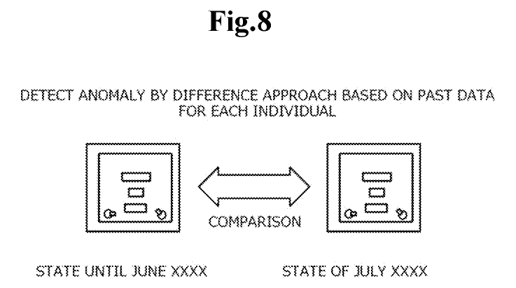

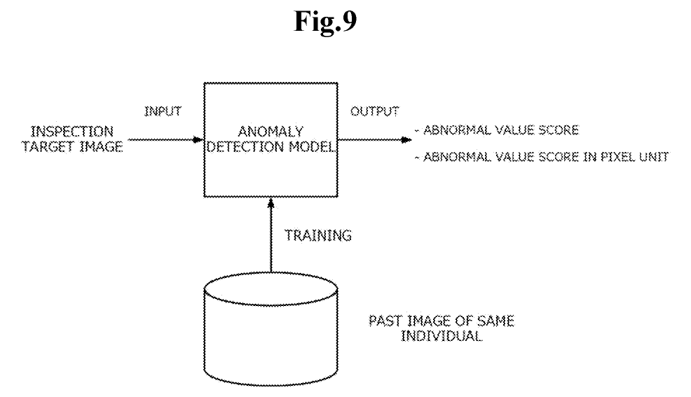

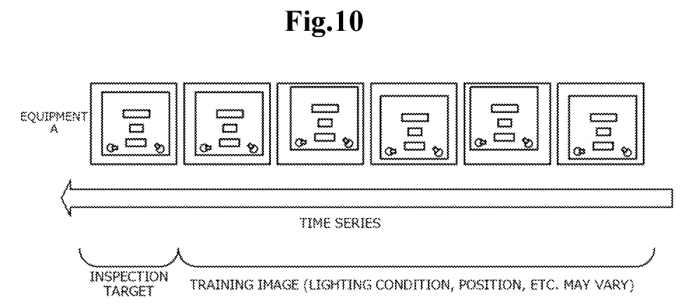

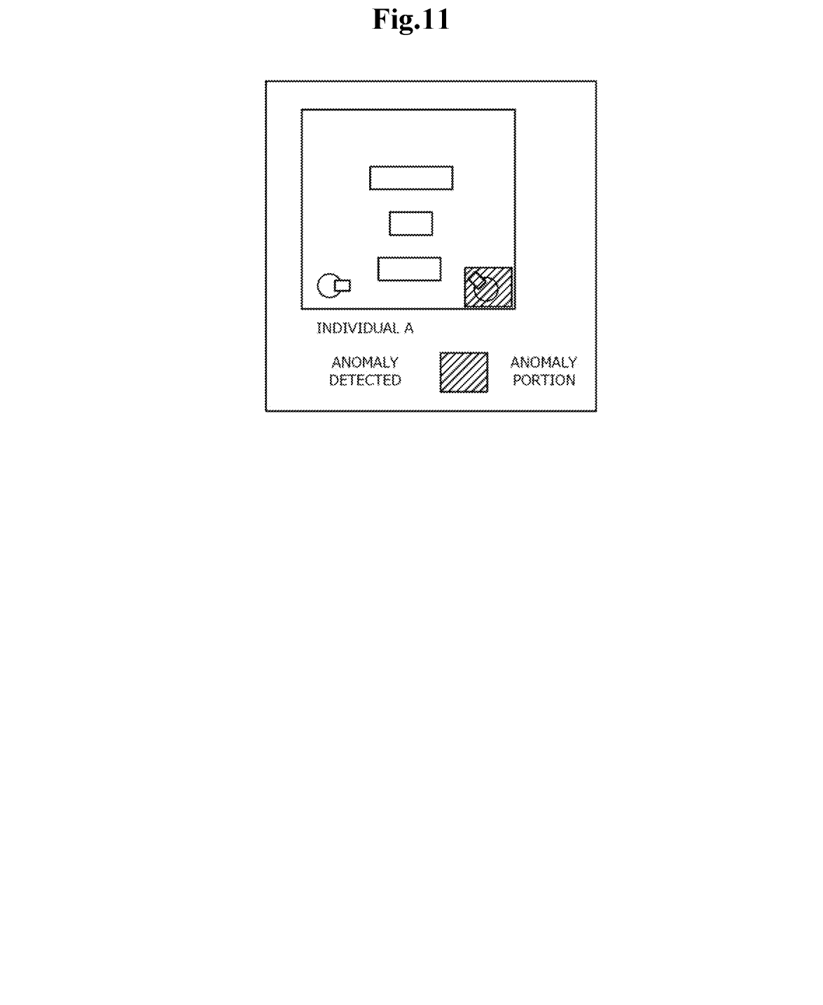

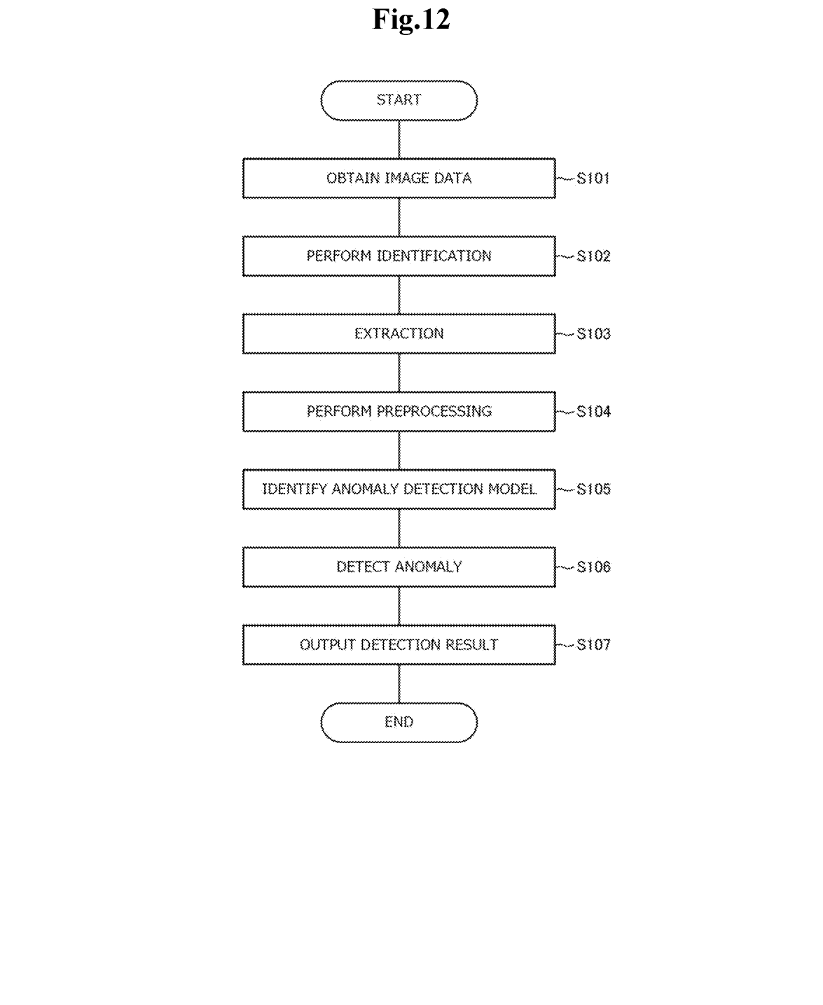

An exemplary configuration of an anomaly detection system 100 according to the present disclosure will be described with reference to FIGS. 1 to 12. FIG. 1 is a diagram illustrating an outline of the anomaly detection system 100. FIG. 2 is a block diagram illustrating an exemplary configuration of an anomaly detection device 300. FIG. 3 is a diagram illustrating exemplary processing of a target extraction unit 353. FIG. 4 is a diagram illustrating an outline of a master image update. FIG. 5 is a diagram for explaining an exemplary process of the master image update. FIG. 6 is a diagram illustrating exemplary frames to be used for the master image update. FIG. 7 is a diagram illustrating exemplary preprocessing. FIG. 8 is a diagram illustrating an outline of an anomaly detection process. FIG. 9 is a diagram illustrating exemplary processing of an anomaly detection unit 355. FIG. 10 is a diagram for explaining exemplary images to be used for anomaly detection. FIG. 11 is a diagram illustrating an exemplary output of an output unit 356. FIG. 12 is a flowchart illustrating an exemplary operation of the anomaly detection device 300. In the present disclosure, the drawings may be associated with one or more example embodiments.

In the present disclosure, the anomaly detection system 100 that performs anomaly detection using image data will be described. For example, the anomaly detection system 100 obtains image data including an inspection target as a subject, and identifies the inspection target included in the image data using identification information for identifying the inspection target. For example, the anomaly detection system 100 identifies the inspection target using radio frequency identification (RFID) or the like while simultaneously obtaining the image data. The anomaly detection system 100 may identify the inspection target by grasping the identification information, such as a monitoring camera number relevant to an imaging device 200 that has obtained the image data, grasping a vehicle body number present in the image data, or the like. The anomaly detection system 100 further detects an anomaly by comparison with past data of each individual for the identified individual to be inspected. For example, the anomaly detection system 100 performs the anomaly detection by using a trained model or the like, which has been trained using past image data or the like including the individual as a subject. With such a configuration, the anomaly detection system 100 appropriately performs the anomaly detection without detecting dirt or the like that accumulates over time on the individual as an anomaly. In other words, the anomaly detection system 100 detects an anomaly in consideration of circumstances unique to the individual to be inspected by performing the anomaly detection according to a difference approach based on the past data of the individual.

The anomaly detection system 100 may extract the inspection target from the image data by extracting a portion similar to a pre-registered master image included in the image data. At this time, the master image may be common to a plurality of individuals that may be subject to inspection. For example, the master image may be normal image data or the like in which any one of a plurality of individuals of the same type in different installation places is set as a subject. As described above, the anomaly detection system 100 may detect an anomaly by comparison with past data of each individual while extracting the inspection target using the master image common to each individual. For example, the anomaly detection system 100 may identify the individual by identifying a train or the like in which the individual to be inspected is arranged by identification processing and specifying a position or the like of the individual as a result of the extraction processing described above.

The anomaly detection system 100 may also detect an anomaly after performing predetermined preprocessing on the image data. For example, the anomaly detection system 100 may perform at least one of preprocessing such as brightness correction, background removal, alignment (or shape transformation), and the like. The anomaly detection system 100 may perform any preprocessing other than those exemplified above.

FIG. 1 illustrates the outline of the anomaly detection system 100 described in the present disclosure. Referring to FIG. 1, the anomaly detection system 100 includes the imaging device 200 and the anomaly detection device 300. As illustrated in FIG. 1, the imaging device 200 and the anomaly detection device 300 may be communicably connected to each other.

As illustrated in FIG. 1, a case where the inspection target is any underfloor device existing under a train car will be described in the present disclosure. At least one underfloor device, which serves as such an inspection target, exists for each train car. Thus, if there is a plurality of train cars, there is a plurality of individuals that may be subject to inspection. As will be described later, the anomaly detection system 100 described in the present disclosure may identify which individual is the inspection target included in the image data, and then detect an anomaly using a trained model relevant to the identified individual.

However, the inspection target is not limited to the case of the underfloor device of the train car exemplified in FIG. 1. The inspection target may be any target in which a plurality of individuals that may be subject to inspection exists. For example, the inspection target may be any device installed outdoors, such as an outdoor unit. The inspection target may be any device installed in a plant, factory, or the like, or may be any object.

The imaging device 200 obtains image data in which the underfloor device of the train car, which serves as the inspection target, is set as a subject. The imaging device 200 may obtain time-series image data, such as video. The imaging device 200 transmits the obtained image data to the anomaly detection device 300. The imaging device 200 may transmit, to the anomaly detection device 300, identification information such as an imaging device number assigned to the imaging device 200 in advance together with the image data. The identification information may be transmitted at the same timing as the image data, or at different timing. The imaging device 200 may obtain the image data to include a vehicle body number and the like while setting the inspection target as a subject. The imaging device 200 may obtain the image data in which the inspection target is set as a subject and the image data including the vehicle body number at different timings.

The anomaly detection device 300 is an information processing apparatus that performs anomaly detection using image data. FIG. 2 illustrates a main configuration example of the anomaly detection device 300. Referring to FIG. 2, the anomaly detection device 300 includes, as main components, an operation input unit 310, a screen display unit 320, a communication interface unit 330, a storage unit 340, and an arithmetic processing unit 350.

FIG. 2 exemplifies a case where functions of the anomaly detection device 300 are implemented using a single information processing apparatus. However, at least some of the functions of the anomaly detection device 300 may be implemented using a plurality of the information processing apparatuses, such as by being implemented on a cloud. The anomaly detection device 300 may not include some of the exemplified components, such as not including the operation input unit 310 and the screen display unit 320, or may include components other than those exemplified above.

The operation input unit 310 includes an operation input device, such as a keyboard, a mouse, or the like. The operation input unit 310 detects an operation of an operator who operates the anomaly detection device 300, and outputs the operation to the arithmetic processing unit 350.

The screen display unit 320 includes a screen display device, such as a liquid crystal display, organic electro-luminescence (EL), or the like. The screen display unit 320 may display, on a screen, various types of information stored in the storage unit 340 or the like, in response to an instruction from the arithmetic processing unit 350 or the like.

The communication interface unit 330 includes a data communication circuit or the like. The communication interface unit 330 performs data communication with an external device connected via a communication line.

The storage unit 340 is a storage device, such as a hard disk, a memory, or the like. The storage unit 340 stores processing information required for various types of processing of the arithmetic processing unit 350 and a program 344. The program 344 is read and executed by the arithmetic processing unit 350 to achieve various processing units. The program 344 is read from an external device or a recording medium in advance via a data input/output function, such as the communication interface unit 330, and is saved in the storage unit 340. Examples of main information stored in the storage unit 340 include extraction model information 341, anomaly detection model information 342, and image data information 343.

The extraction model information 341 includes information regarding a target extraction model, which is a model to be used to extract the inspection target from the image data. The extraction model information 341 may be obtained in advance by, for example, being received from an external device via the communication interface unit 330, and stored in the storage unit 340.

In the case of the present disclosure, the extraction model information 341 includes a target extraction model, such as a few-shot object detection model for extracting a portion similar to the pre-registered master image included in the image data. As described above, the master image common to each individual may be registered in the target extraction model. The master image to be registered in the target extraction model may be appropriately added by addition processing to be described later. The master image registered in the target extraction model may be deleted according to any condition, such as deletion after elapse of a predetermined number of days, deletion from the oldest image if the number of registered images is equal to or more than a predetermined number, or the like.

The anomaly detection model information 342 includes information regarding an anomaly detection model, which is a model to be used for anomaly detection. For example, the anomaly detection model information 342 may include information regarding the anomaly detection model relevant to each individual. The anomaly detection model information 342 may be obtained in advance by, for example, being received from an external device via the communication interface unit 330, and stored in the storage unit 340.

As described above, the anomaly detection model information 342 may include a relevant anomaly detection model for each individual that may be subject to inspection. Here, the anomaly detection model is a model trained using normal-state image data of the relevant individual obtained in the past. The training is carried out for each individual without combining a plurality of individuals, whereby the anomaly detection may be performed in consideration of individual-specific characteristics, such as dirt that accumulates over time on the individual.

The image data information 343 includes the image data to be subject to the anomaly detection. The image data information 343 may be updated by an acquisition unit 351 obtaining the image data, for example.

The arithmetic processing unit 350 includes an arithmetic device, such as a central processing unit (CPU), and peripheral circuits thereof. The arithmetic processing unit 350 causes the hardware to cooperate with the program 344 to achieve various processing units by reading and executing the program 344 from the storage unit 340. Examples of a main processing unit achieved by the arithmetic processing unit 350 include the acquisition unit 351, an identification unit 352, the target extraction unit 353, a preprocessing unit 354, the anomaly detection unit 355, and the output unit 356.

Instead of the CPU described above, the arithmetic processing unit 350 may include a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination thereof, or the like.

The acquisition unit 351 obtains the image data to be subject to the anomaly detection from the imaging device 200 or any other external device. The acquisition unit 351 stores the obtained image data in the storage unit 340 as the image data information 343.

The acquisition unit 351 may further obtain the identification information, which is information for identifying the inspection target. For example, the acquisition unit 351 may obtain image data for identification, such as image data including a vehicle body number. In that case, the acquisition unit 351 may extract, from the image data, the identification information, such as information indicating the vehicle body number included in the image data, by performing any character recognition processing or the like. The image data for identification may be the same as or different from the image data to be subject to the anomaly detection. In addition to or instead of the processing described above, the acquisition unit 351 may perform at least one of acquisition of the identification information using RFID, acquisition of the identification information such as an imaging device number from the imaging device 200, and the like. The acquisition unit 351 may obtain the identification information by any other method.

The identification unit 352 performs identification using the identification information obtained by the acquisition unit 351. For example, the identification unit 352 identifies the train car or the like provided with the individual to be subject to inspection by referring to the identification information obtained by the acquisition unit 351. The identification unit 352 may identify the individual associated with the train car as a result of the identification. The identification unit 352 may perform the identification described above by, for example, referring to information stored in advance in which the identification information such as the imaging device number is associated with the information indicating the train car or the like.

The target extraction unit 353 extracts the inspection target from the image data obtained by the acquisition unit 351. For example, the target extraction unit 353 extracts, from the image data, an image relevant to the inspection target by extracting a portion similar to the pre-registered master image in the image data.

FIG. 3 illustrates an exemplary extraction process performed by the target extraction unit 353. Referring to FIG. 3, the target extraction unit 353 inputs the image data to the target extraction model. As a result, the target extraction model extracts a portion similar to the pre-registered master image in the image data. For example, the target extraction model extracts, as a portion similar to the master image, a candidate having a certainty factor of equal to or more than a predetermined threshold among one or a plurality of candidates extracted from the image data. As a result, by obtaining an output from the target extraction model, the target extraction unit 353 is enabled to extract the inspection target from the image data. The certainty factor refers to a value indicating a level of confidence of the extraction by the model. For example, a value of the certainty factor is larger as similarity to the master image determined by the model is higher.

The master image to be used to extract the inspection target may be added if, for example, any condition is satisfied. For example, as illustrated in FIG. 4, the target extraction unit 353 may register, as a master image, an image satisfying a predetermined condition among normal images including the inspection target extracted from the normal image data.

For example, referring to FIG. 5, the target extraction unit 353 stocks, as normal images, images of the inspection target in which coordinates of an extraction frame are not at the end of the entire image among the inspection targets extracted from the normal image data. In other words, the target extraction unit 353 stocks, as normal images, images of the inspection target that may be determined not to be cut off. The target extraction unit 353 adds, as a master image, an image whose certainty factor is less than a predetermined threshold among the images stocked as the normal images. In this manner, the target extraction unit 353 adds, as a master image, an image determined not to be similar to the master image among the images stocked as the normal images. By performing such addition processing, robustness may improve even if the extraction is performed using a small amount of master images.

The target extraction unit 353 may periodically add the master image every month, for example. The target extraction unit 353 may add the master image if any other condition is satisfied.

In a case of adding the master image using video of a normal time or the like, the target extraction unit 353 may stock the normal images using image data for each M frames. At this time, a value of M may be optionally set. As illustrated in FIG. 6, the target extraction unit 353 may select one frame satisfying a predetermined condition for each M frames, and may stock the normal images using the image data of the selected frame. The condition at the time of selecting the frame may be at least one of the following examples:

Whether one or more inspection targets are extracted;

Whether one or more inspection targets whose coordinates of the extraction frame are not at the end of the entire image are extracted; and

Whether the certainty factor is maximum in M frames.

For example, if the normal images are stocked from all frames, there is a possibility that master images to be added and candidates thereof are excessively increased. With the thinning process as described above, the possibility described above may be suppressed.

The target extraction unit 353 may delete the master image if any condition is satisfied, for example. For example, the target extraction unit 353 may delete an image in which the number of elapsed days from registration exceeds a predetermined number among the images registered as the master images. The target extraction unit 353 may delete old images if the number of registered master images is equal to or more than a predetermined number. The target extraction unit 353 may delete some of the images registered as the master images if any other condition is satisfied.

The preprocessing unit 354 performs predetermined preprocessing on the image of the inspection target extracted by the target extraction unit 353. FIG. 7 illustrates an example of the preprocessing performed by the preprocessing unit 354. Referring to FIG. 7, the preprocessing unit 354 may perform at least one of preprocessing such as brightness correction, background removal, alignment (or shape transformation), and the like. The preprocessing unit 354 may perform any preprocessing other than those exemplified above.

For example, the preprocessing unit 354 may perform each preprocessing by, for example, inputting the image of the inspection target to a trained model relevant to each preprocessing. For example, the preprocessing unit 354 may perform the brightness correction using a trained model for brightness correction trained in advance. The preprocessing unit 354 may perform the background removal using a trained model for background removal trained in advance. The preprocessing unit 354 may perform preprocessing such as shape transformation, alignment, or the like by performing feature point matching using a trained model trained in advance and then performing homography transformation or the like.

The preprocessing unit 354 may determine whether to perform each preprocessing depending on image data acquisition environment, image data conditions, and the like. For example, the preprocessing unit 354 may omit the brightness correction in a case where the image data is assumed to be obtained in a constantly bright environment, for example. The preprocessing unit 354 may perform the brightness correction if a brightness histogram may be determined to be biased to the left side, for example. The preprocessing unit 354 may perform the background removal if the background is determined to be complex. Whether the background is complex may be determined in advance at the stage of obtaining the image data, or may be determined from the image data using any means. The preprocessing unit 354 may perform the preprocessing of the alignment if the position of the inspection target is not fixed, such as a case where the position of the imaging device 200 is not fixed, a case where the inspection target is a moving object, or the like. The preprocessing unit 354 may determine whether to perform the preprocessing by checking conditions other than any conditions exemplified above.

The anomaly detection unit 355 performs the anomaly detection using the image data. For example, as illustrated in FIG. 8, the anomaly detection unit 355 may perform the anomaly detection according to a difference approach based on the past data of the individual using the anomaly detection model, which is a trained model. The anomaly detection unit 355 may detect a portion where an anomaly has occurred in the image data as well as detecting presence or absence of an anomaly in the entire image data using the anomaly detection model.

For example, the anomaly detection unit 355 specifies the anomaly detection model to be used for the anomaly detection by identifying the individual to be subject to the inspection as a result of the identification by the identification unit 352. The anomaly detection unit 355 may identify the individual to be subject to the inspection using a result of the identification by the identification unit 352 and a result of the extraction by the target extraction unit 353. For example, the anomaly detection unit 355 may identify the individual to be subject to the inspection by using a result of the identification by the identification unit 352, a position of the inspection target that may be identified as a result of the extraction by the target extraction unit 353, and the like.

As illustrated in FIG. 9, the anomaly detection unit 355 inputs the preprocessed image to be subject to the inspection to the specified anomaly detection model. As a result, the anomaly detection model detects the presence or absence of an anomaly and outputs a detection result. For example, the anomaly detection model calculates and outputs an abnormal value score of the entire image. At this time, the anomaly detection model may assign an anomaly flag if the overall abnormal value score is equal to or more than a predetermined threshold. The anomaly detection model may calculate and output the abnormal value score in units of pixels. The abnormal value score in units of pixels may be displayed on a heat map or the like at a time of anomaly portion visualization.

As described above, the anomaly detection model to be used by the anomaly detection unit 355 to perform the anomaly detection is associated with the individual to be subject to the anomaly detection. In other words, as illustrated in FIG. 9, the anomaly detection model to be used by the anomaly detection unit 355 is trained using the past image data of the individual to be subject to the anomaly detection. For example, FIG. 10 illustrates exemplary time-series image data obtained for a certain individual. Referring to FIG. 10, it may be seen that the anomaly detection model is trained using the past image data, the anomaly detection is performed on the image to be subject to the inspection using the anomaly detection model trained using the method described above, and the like. The past image data may vary in lighting conditions, positions, and the like as long as the individuals are the same. With the past image data that varies in lighting conditions and positions being used for the training, the anomaly detection robust to variations in lighting conditions, positions, and the like may be achieved. The anomaly detection model to be used by the anomaly detection unit 355 to perform the anomaly detection may be periodically retrained, for example. A frequency of the retraining and the like may be adjusted optionally.

The output unit 356 outputs, for example, a result of the detection by the anomaly detection unit 355. For example, the output unit 356 may display the result of the detection by the anomaly detection unit 355 or the like on the screen display unit 320, or may transmit the result to an external device via the communication interface unit 330.

FIG. 11 illustrates an exemplary output of the output unit 356. Referring to FIG. 11, the output unit 356 may output at least some of the image data of the individual serving as the inspection target, presence or absence of the anomaly flag, the heat map for the anomaly portion visualization, and the like. For example, in the case of FIG. 11, a hatched portion corresponds to a portion where an anomaly is confirmed by the abnormal value score in units of pixels. With the output as illustrated in FIG. 11, the portion determined as an anomaly may be easily confirmed together with the presence or absence of an anomaly.

The exemplary configuration of the anomaly detection device 300 has been described above. Next, an exemplary operation of the anomaly detection device 300 will be described with reference to FIG. 12. FIG. 12 illustrates an exemplary operation of the anomaly detection device 300, and the operation of the anomaly detection device 300 is not limited to the case exemplified in FIG. 12. For example, processing of step S103, processing of step S104, and the like may be omitted.

FIG. 12 is a flowchart illustrating an exemplary operation of the anomaly detection device 300. Referring to FIG. 12, the acquisition unit 351 obtains the image data to be subject to the anomaly detection from the imaging device 200 or the like (step S101). The acquisition unit 351 may further obtain information for identification.

The identification unit 352 performs identification using the identification information obtained by the acquisition unit 351 (step S102). For example, the identification unit 352 may identify the train car or the like provided with the individual to be subject to the inspection by referring to the identification information obtained by the acquisition unit 351.

The target extraction unit 353 extracts the inspection target from the image data obtained by the acquisition unit 351 (step S103). For example, the target extraction unit 353 extracts, from the image data, an image relevant to the inspection target by extracting a portion similar to the pre-registered master image in the image data.

The preprocessing unit 354 performs predetermined preprocessing on the image of the inspection target extracted by the target extraction unit 353 (step S104). The preprocessing unit 354 may perform at least one of the preprocessing such as brightness correction, background removal, alignment, and the like.

The anomaly detection unit 355 performs the anomaly detection using the image data. For example, the anomaly detection unit 355 specifies the anomaly detection model to be used for the anomaly detection by identifying the individual to be subject to the inspection as a result of the identification by the identification unit 352 (step S105). The anomaly detection unit 355 may identify the individual to be subject to the inspection using a result of the identification by the identification unit 352 and a result of the extraction by the target extraction unit 353. The anomaly detection unit 355 performs the anomaly detection by, for example, inputting the image to be subject to the inspection preprocessed by the processing of step S104 to the anomaly detection model (step S106).

The output unit 356 outputs, for example, a result of the detection by the anomaly detection unit 355 (step S107). The output unit 356 may display the result of the detection by the anomaly detection unit 355 or the like on the screen display unit 320, or may transmit the result to an external device via the communication interface unit 330.

The exemplary operation of the anomaly detection device 300 has been described above.

As described above, the anomaly detection device 300 includes the identification unit 352 and the anomaly detection unit 355. According to such a configuration, the anomaly detection unit 355 may specify the anomaly detection model using the result of the identification by the identification unit 352, and may perform the anomaly detection using the specified anomaly detection model. As a result, the anomaly detection may be performed using the anomaly detection model trained for each individual. In this manner, the anomaly detection device 300 may appropriately perform the anomaly detection without detecting dirt or the like that accumulates over time on the individual as an anomaly. In other words, in the case of performing the anomaly detection based on training using an image of a normal time, there is a possibility that individual-specific circumstances, such as dirt, may be detected as an anomaly. According to the anomaly detection device 300 described in the present disclosure, the anomaly detection is performed using the model trained for each individual, whereby the possibility mentioned above may be suppressed.

The anomaly detection device 300 further includes the target extraction unit 353. According to such a configuration, the anomaly detection unit 355 may perform the anomaly detection on the image extracted by the target extraction unit 353. As a result, the anomaly detection may be performed while suppressing required effort and the like. As described above, the target extraction unit 353 may perform the extraction using the master image common to each individual. Since a difference from a normal state is not taken at the time of object extraction, there is a low possibility that a problem is raised due to implementation using a general-purpose image. The anomaly detection is performed by comparison with the past data for each individual while extracting the inspection target using the master image common to each individual, whereby the anomaly detection may be performed appropriately while suppressing a load associated with the anomaly detection.

The anomaly detection device 300 further includes the preprocessing unit 354. According to such a configuration, the anomaly detection unit 355 may perform the anomaly detection using the image preprocessed by the preprocessing unit 354. In a case of performing the anomaly detection using a difference from a normal state, there is a possibility that an anomaly is erroneously detected due to an influence of a disturbance, such as variations in weather or time period, variations in camera position or the like, or variations in irrelevant portion such as background or the like. According to the preprocessing as described above, the anomaly detection may be performed while suppressing the influence of the disturbance. In other words, according to the processing described above, the anomaly detection device 300 may perform the anomaly detection more appropriately while coping with the difference between the disturbance and the anomaly.

### Second Example Embodiment

Next, a modified example of the anomaly detection device 300 will be described. The exemplary configuration of the anomaly detection device 300 has been described in the first example embodiment with reference to FIG. 2. However, the configuration of the anomaly detection device 300 is not limited to the case exemplified in FIG. 2.

For example, the anomaly detection device 300 may not include at least one of the target extraction unit 353, the preprocessing unit 354, and the like in the configuration exemplified in FIG. 2. For example, if the anomaly detection device 300 does not include the target extraction unit 353, the anomaly detection unit 355 may detect an anomaly by inputting, for example, the entire image data obtained by the acquisition unit 351 to the anomaly detection model. If the anomaly detection device 300 does not include the preprocessing unit 354, the anomaly detection unit 355 may detect an anomaly by inputting, for example, the image extracted by the target extraction unit 353 to the anomaly detection model.

For example, as described above, the anomaly detection device 300 may include some of the components described in the first example embodiment. The anomaly detection device 300 may not include the target extraction unit 353 if it is clear that only one inspection target is present in the image data, if a ratio of the inspection target in the image data satisfies a condition, or the like. The anomaly detection device 300 may not include the preprocessing unit 354 if, for example, the inspection target is indoor equipment and a disturbance is determined to be small. The components included in the anomaly detection device 300 may be selected according to any other conditions.

### Third Example Embodiment

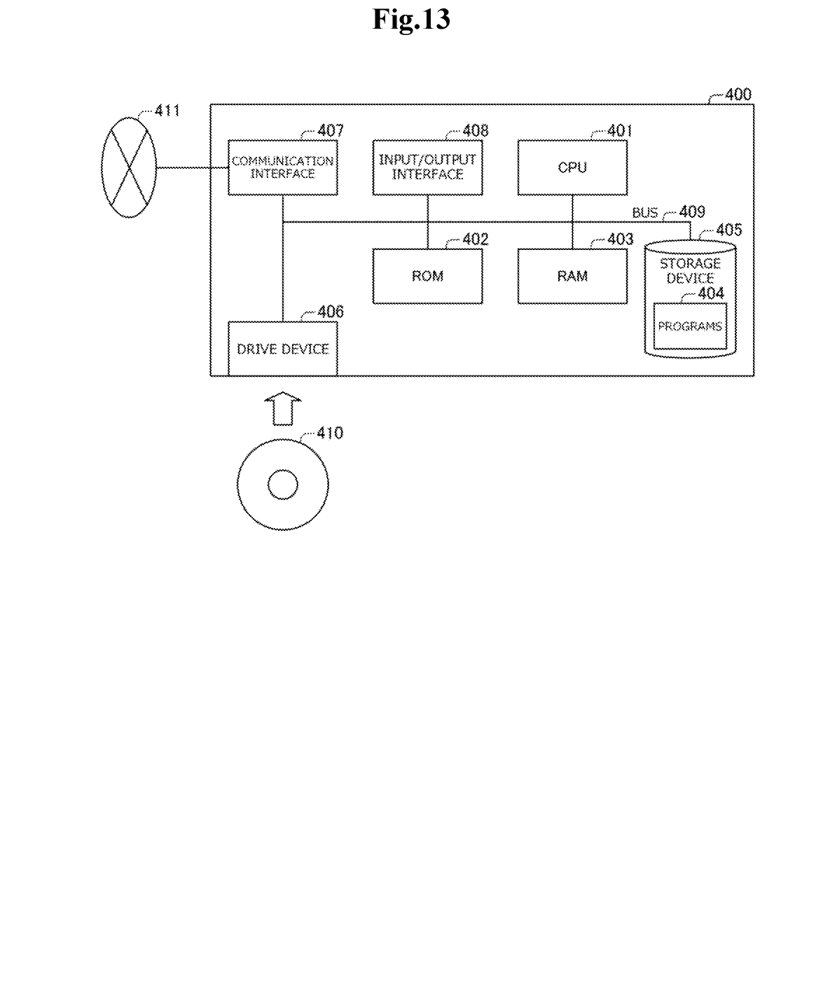

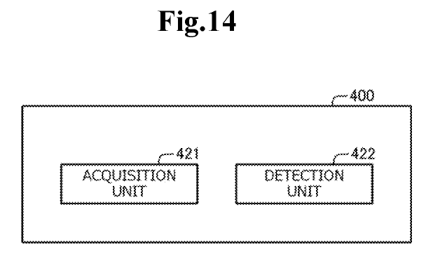

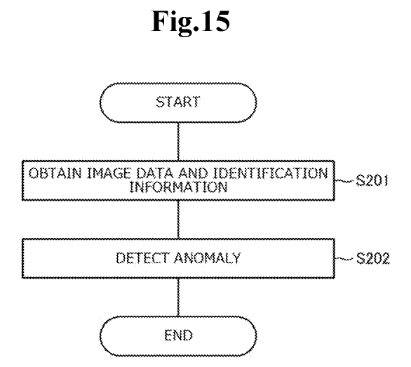

Next, an information processing apparatus 400, which is another modified example of the anomaly detection device 300, will be described with reference to FIGS. 13 to 15. FIG. 13 is a diagram illustrating an exemplary hardware configuration of the information processing apparatus 400. FIG. 14 is a block diagram illustrating an exemplary configuration of the information processing apparatus 400. FIG. 15 is a flowchart illustrating an exemplary operation of the information processing apparatus 400.

The information processing apparatus 400 is an apparatus that detects an anomaly using image data. FIG. 13 illustrates an exemplary hardware configuration of the information processing apparatus 400. Referring to FIG. 13, as an example, the information processing apparatus 400 includes the following hardware configuration:

Central processing unit (CPU) 401 (arithmetic device);

Read only memory (ROM) 402 (storage device);

Random access memory (RAM) 403 (storage device);

Programs 404 to be loaded into RAM 403;

Storage device 405 storing programs 404;

Drive device 406 for performing reading/writing on a recording medium 410 outside the information processing apparatus 400;

Communication interface 407 connected to a communication network 411 outside the information processing apparatus 400;

Input/output interface 408 for performing data input/output; and

Bus 409 connecting components.

The information processing apparatus 400 may implement functions of an acquisition unit 421 and a detection unit 422 illustrated in FIG. 14 by the CPU 401 obtaining the programs 404 and the CPU 401 executing the programs. The programs 404 are stored in, for example, the storage device 405 or the ROM 402 in advance, and the CPU 401 loads them into the RAM 403 or the like to execute them as necessary. The programs 404 may be supplied to the CPU 401 via the communication network 411, or the drive device 406 may read the programs stored in the recording medium 410 in advance to supply them to the CPU 401.

FIG. 13 illustrates an exemplary hardware configuration of the information processing apparatus 400. The hardware configuration of the information processing apparatus 400 is not limited to the case described above. For example, the information processing apparatus 400 may include some of the components described above, such as including no drive device 406. The CPU 401 may be a GPU or the like exemplified in the first example embodiment.

The acquisition unit 421 obtains image data including an inspection target as a subject, and identification information for identifying the inspection target. For example, the acquisition unit 421 obtains the image data including the inspection target and the identification information, for example, from an imaging device or any other external device, thereby obtaining the image data and the identification information at the same timing. The acquisition unit 421 may obtain the identification information at timing different from that of the image data by, for example, obtaining the image data including the inspection target and obtaining the identification information from the imaging device or any other external device.

The detection unit 422 detects an anomaly by comparing an individual, which is identified according to the identification information and is to be subject to the inspection, with past data of each individual. For example, a trained model for anomaly detection is trained for each individual using the past data of each individual. The detection unit 422 may specify the trained model to be used for the anomaly detection according to a result of the identification using the identification information, whereby the anomaly detection using the specified trained model may be performed.

The exemplary configuration of the information processing apparatus 400 has been described above. Next, an exemplary operation of the information processing apparatus 400 will be described with reference to FIG. 15.

FIG. 15 is a flowchart illustrating an exemplary operation of the information processing apparatus 400. Referring to FIG. 15, the acquisition unit 421 obtains the image data including the inspection target as a subject, and the identification information for identifying the inspection target (step S201).

The detection unit 422 detects an anomaly by comparing, with the past data of each individual, the individual to be subject to the inspection identified using the identification information (step S203). For example, the detection unit 422 may perform the anomaly detection using the trained model that may be specified according to the identification result.

As described above, the information processing apparatus 400 includes the detection unit 422. According to such a configuration, the detection unit 422 may detect an anomaly by comparing, with the past data of each individual, the individual to be subject to the inspection identified using the identification information. As a result, the information processing apparatus 400 may appropriately perform the anomaly detection without detecting dirt or the like that accumulates over time on the individual as an anomaly.

The information processing apparatus 400 described above may be achieved by a predetermined program being incorporated into an apparatus such as the information processing apparatus 400. Specifically, a program according to another aspect of the present disclosure is a program for causing a device such as the information processing apparatus 400 to perform a process of obtaining image data including an inspection target as a subject and identification information for identifying the inspection target and detecting an anomaly by comparing an individual that serves as the inspection target identified according to the identification information with past data for each individual.

An information processing method to be executed by a device such as the information processing apparatus 400 described above is a method for causing the device such as the information processing apparatus 400 to obtain the image data including the inspection target as a subject and the identification information for identifying the inspection target, and to detect an anomaly by comparing the individual that serves as the inspection target identified according to the identification information with the past data for each individual.

Even with a program, a computer-readable recording medium recording the program, an information processing method, or the like having the configuration described above, operations and effects similar to those of the information processing apparatus 400 described above may be exerted, and thus an object of the present disclosure described above may be achieved.

### Supplementary Note

Some or all of the above example embodiments may be described as in the following Supplementary Notes. Hereinafter, an outline of the information processing apparatus or the like according to the present disclosure will be described. However, the present disclosure is not limited to the following configurations.

### Supplementary Note 1

An information processing apparatus including:

an acquisition unit that obtains image data including an inspection target as a subject and identification information for identifying the inspection target; and

a detection unit that detects an anomaly by comparing an individual that serves as the inspection target identified according to the identification information with past data for each individual.

### Supplementary Note 2

The information processing apparatus according to Supplementary Note 1,

in which the detection unit detects presence or absence of the anomaly as the image data, and detects a portion where the anomaly has occurred in the image data.

Supplementary Note 3

### The information processing apparatus according to Supplementary Note 1 or 2, further including:

an extraction unit that extracts the inspection target from the image data, in which

the extraction unit extracts a portion similar to a pre-registered master image in the image data to extract the inspection target from the image data, and

the master image includes an image common to a plurality of the individuals that may serve as the inspection target.

### Supplementary Note 4

The information processing apparatus according to any one of Supplementary Notes 1 to 3, further including:

a preprocessing unit that performs predetermined preprocessing on the image data,

in which the detection unit detects the anomaly by comparing the inspection target included in the image data preprocessed by the preprocessing unit with the past data for each individual.

### Supplementary Note 5

The information processing apparatus according to any one of Supplementary Notes 1 to 4,

in which the detection unit detects the anomaly using a trained model trained in advance, and the trained model includes a model trained using the past data, which is an image previously obtained for the individual that serves as the inspection target.

### Supplementary Note 6

The information processing apparatus according to Supplementary Note 5, in which

the trained model is trained for each individual that serves as the inspection target, and

the detection unit specifies the trained model to be used to detect the anomaly according to an identification result, and detects the anomaly using the specified trained model.

### Supplementary Note 7

The information processing apparatus according to Supplementary Note 3,

in which the extraction unit adds, as the master image, an image that satisfies a predetermined condition among images indicating the inspection target extracted using the image data in a normal state.

### Supplementary Note 8

The information processing apparatus according to any one of Supplementary Notes 1 to 7,

in which the detection unit detects the anomaly in consideration of a circumstance unique to the individual that serves as the inspection target.

### Supplementary Note 9

An information processing method for causing an information processing apparatus to perform a process including:

obtaining image data including an inspection target as a subject and identification information for identifying the inspection target; and

detecting an anomaly by comparing an individual that serves as the inspection target identified according to the identification information with past data for each individual.

### Supplementary Note 10

A program for causing an information processing apparatus to perform a process including:

obtaining image data including an inspection target as a subject and identification information for identifying the inspection target; and

detecting an anomaly by comparing an individual that serves as the inspection target identified according to the identification information with past data for each individual.

Some or all of the configurations described in Supplementary Notes 2 to 8 dependent on the information processing apparatus described in Supplementary Note 1 may also be dependent on the information processing method described in Supplementary Note 9, the program described in Supplementary Note 10, and the like by a similar dependency relationship. Some or all of the configurations described in Supplementary Notes may be similarly dependent on not only Supplementary Notes 9 and 10 but also various pieces of hardware and software, various types of recording means for recording software, methods, programs, or systems without departing from the example embodiments described above.

The program described in the example embodiments and Supplementary Notes described above may be stored using various types of non-transitory computer-readable media and supplied to a computer. The non-transitory computer readable media include various types of tangible storage media. Examples of the non-transitory computer readable media include a magnetic recording medium (e.g., flexible disk, magnetic tape, or hard disk drive), an optical magnetic recording medium (e.g., magneto-optical disk), a compact disc read only memory (CD-ROM), a CD-R, a CD-R/W, and a semiconductor memory (e.g., mask ROM, programmable ROM (PROM), erasable PROM (EPROM), flash ROM, or random access memory (RAM)). The program may be supplied to the computer by various types of transitory computer readable media. Examples of the transitory computer readable media include electrical signals, optical signals, and electromagnetic waves. The transitory computer readable media may supply the program to the computer via a wired communication line such as an electric wire and an optical fiber, or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### Reference Signs List

100 anomaly detection system

200 imaging device

300 anomaly detection device

310 operation input unit

320 screen display unit

330 communication interface unit

340 storage unit

341 extraction model information

342 anomaly detection model information

343 image data information

344 program

350 arithmetic processing unit

351 acquisition unit

352 identification unit

353 target extraction unit

354 preprocessing unit

355 anomaly detection unit

356 output unit

400 information processing apparatus

401 CPU

402 ROM

403 RAM

404 programs

405 storage device

406 drive device

407 communication interface

408 input/output interface

409 bus

410 recording medium

411 communication network

421 acquisition unit

422 detection unit

1. An information processing apparatus comprising:
at least one memory configured to store processing instructions; and
at least one processor configured to execute the processing instructions to:
obtain image data including an inspection target as a subject and identification information for identifying the inspection target; and
detect an anomaly by comparing an individual that serves as the inspection target identified according to the identification information with past data for each individual.

2. The information processing apparatus according to claim 1,
wherein the at least one processor is further configured to detect presence or absence of the anomaly as the image data, and detect a portion where the anomaly has occurred in the image data.

3. The information processing apparatus according to claim 1,
wherein the at least one processor is further configured to:
extract the inspection target from the image data; and
extract a portion similar to a pre-registered master image in the image data to extract the inspection target from the image data, and
the master image includes an image common to a plurality of the individuals that may serve as the inspection target.

4. The information processing apparatus according to claim 1,
wherein the at least one processor is further configured to:
perform predetermined preprocessing on the image data; and
detect the anomaly by comparing the inspection target included in the preprocessed image data with the past data for each individual.

5. The information processing apparatus according to claim 1,
wherein the at least one processor is further configured to detect the anomaly using a trained model trained in advance, and the trained model includes a model trained using the past data, which is an image previously obtained for the individual that serves as the inspection target.

6. The information processing apparatus according to claim 5,
wherein the trained model is trained for each individual that serves as the inspection target, and
the at least one processor is further configured to specify the trained model to be used to detect the anomaly according to an identification result, and detect the anomaly using the specified trained model.

7. The information processing apparatus according to claim 3,
wherein the at least one processor is further configured to add, as the master image, an image that satisfies a predetermined condition among images indicating the inspection target extracted using the image data in a normal state.

8. The information processing apparatus according to claim 1,
wherein the at least one processor is further configured to detect the anomaly in consideration of a circumstance unique to the individual that serves as the inspection target.

9. The information processing apparatus according to claim 1, wherein the at least one processor is further configured to: detect the anomaly using a machine learning model trained with the past data for the individual; and output a result of the detection to a user to support decision making regarding the inspection target.

10. An information processing method for causing an information processing apparatus to perform a process comprising:
obtaining image data including an inspection target as a subject and identification information for identifying the inspection target; and
detecting an anomaly by comparing an individual that serves as the inspection target identified according to the identification information with past data for each individual.

11. A computer-readable storage medium storing a program for causing an information processing apparatus to perform a process comprising:
obtaining image data including an inspection target as a subject and identification information for identifying the inspection target; and
detecting an anomaly by comparing an individual that serves as the inspection target identified according to the identification information with past data for each individual.
